(19) United States
(12) Patent Application Publication
(10) Pub. No.: US 2007/0217856 A1
(43) Pub. Date: Sep. 20, 2007

(54) Portable paint system

(76) Inventors: John M. Kott, Foothill Ranch, CA (US); Kenneth Kott, Foothill Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 11/716,799

(22) Filed: Mar. 12, 2007

Related U.S. Application Data
(60) Provisional application No. 60/784,253, filed on Mar. 20, 2006.

(51) Int. Cl. A46B 17/02; A46B 11/06; B43M 11/02

(52) U.S. Cl. 401/48; 401/219; 401/46

(57) ABSTRACT

A portable cart is provided for roller application viscous coating material using a pressure feed roller. The cart holds a resin container and an activator container, each of which is separately but optionally heated. Material transfer lines run from the containers to a static mixing tube connected to a pressure fed rolling element removably connected to a handle. One or more motors drive one or more pumps to pump the activator and resin through the static mixing tube and rolling element. A switch on the handle controls the pumps and thus controls the material supplied to the rolling element.

### CROSS-REFERENCE TO RELATED APPLICATIONS

This application claims the benefit of U.S. Provisional Application No. 60/784,253 filed Mar. 30, 2006, the entire content of which is hereby incorporated by reference.

### BACKGROUND

This invention relates to a method and apparatus for mixing multi-component products and applying them to a surface using a pressure fed paint roller.

Thick, viscous coating materials are sprayed onto building walls, truck beds, and other items to provide a thick elastomeric coating. The sprayed material is often a plural component urethane/polyurea material. But typical spraying application equipment requires a large source of air and high air pressure. Typical applications require minimum of 7 to 11 CFM at 250-3000 psi. This typically requires the use of a very large and heavy 220 volt air compressor usually weighing hundreds of pounds. Further, the performance of the material is very sensitive to temperature, so either large, heated rooms are typically needed in order to maintain the temperature of the materials at an operating temperature, or else high temperature heat sources are needed with smaller, enclosed areas.

Thinner and much less viscous materials are applied by spraying, but the operators must be carefully trained or else the thinner paint drips and provides an unacceptable aesthetic appearance. The thinner materials are thus commonly applied using paint rollers, with pressurized paint rollers being able to continually feed one or even two different paints to the roller. Such rollers are described in U.S. Pat. Nos. 4,217,062 and 6,331,327, among others. Paint rollers allow a more uniform thickness to be applied than with roller application. Also, rollers do not create the mist or roller cloud that arises when such thin paints are sprayed, and thus there is less masking and fewer environmental issues with roller application rather than roller applications. Moreover, significantly less training is needed for roller application of paint and the uneven application of paint causing dripping is much less common than with sprayed coatings.

But rollers have not been used with multi-part coatings which activate upon mixing. Such use is not logical since the activated coating materials remain on the roller and the roller will thus quickly harden. Moreover, the activated material in the feed mechanism also hardens and will clog if the material remains in the feed mechanism for more than a few minutes. There is thus a need for a method and apparatus allowing roller application of such multi-part coatings.

### BRIEF SUMMARY

A portable coating system is provided having two containers of material in fluid communication with a material transfer line in fluid communication with a mixer tube that is connected to a pressure feed roller. A motor powers two pumps that move the coating materials through the material lines to the pressure feed roller. The static mixing tube is interposed between the roller and the material lines to mix the plural components of the coating material right before the mixed materials are pressure fed through a rolling element and rolled onto the surface being coated. A switch on the handle of the pressure feed roller allows an operator to start and stop the pumps to control the amount of material provided to the pressure feed roller. The switch is preferably electric. When coating is completed, the static mixing tube and rolling element are removed and discarded.

The material lines are preferably unheated, but could be wrapped with low power heaters to maintain the materials at a desirable operating temperature, while reducing power requirements. The material transfer lines can connect to inlet fittings on a manifold which combines the plural fluid inlets into a single outlet in fluid communication with the static mixing tube. The containers holding the materials are optionally provided with heaters, even individual, temperature controlled heaters, and preferably low power resistance heaters.

The roller can fit into a portable cart sufficiently small that a single person can move the cart, and the cart can fit into an elevator. The entire roller application system preferably runs off of a single 110 volt standard power outlet.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a roller system;

FIG. 2 is a schematic view of components used in the roller system of FIG. 1;

FIG. 3 is a plan view of an electrical control panel used in the roller system of FIG. 1;

FIG. 4 is a plan view of a pressure control panel used in the roller system of FIG. 1;

FIG. 5 is a schematic view of a pumping arrangement used in the roller system of FIG. 1;

FIG. 6 is a side plan view of a pressure feed roller, static mixing tube and handle;

FIG. 7 is an exploded view of one exemplary pressure feed roller for use with the roller system of FIG. 1;

FIG. 8 is a view of a further embodiment of a pressure feed roller, handle and static mixing tube;

FIG. 9 is a sectional view of a further embodiment of a pump;

FIG. 10 is a partial sectional view taken along 10-10 of FIG. 9;

FIG. 11 is a side view of a pressure feed roller with the rolling element cut-away;

FIG. 12 is a cross-section of an end cap for the pressure feed roller of FIG. 11; and

FIG. 13 is a cross sectional view of a mixing tube connected to a manifold and bent fluid tube;.

### DETAILED DESCRIPTION

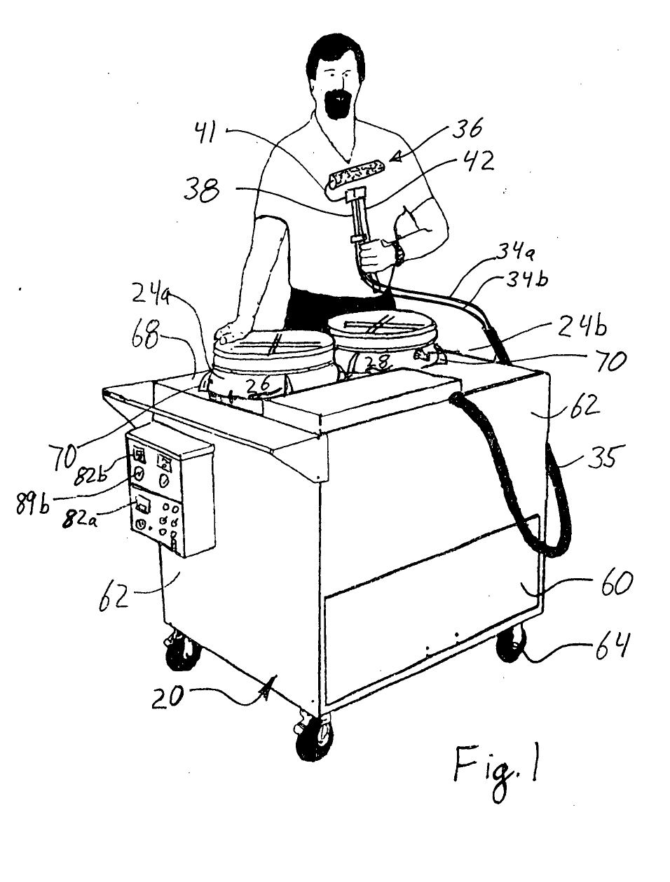

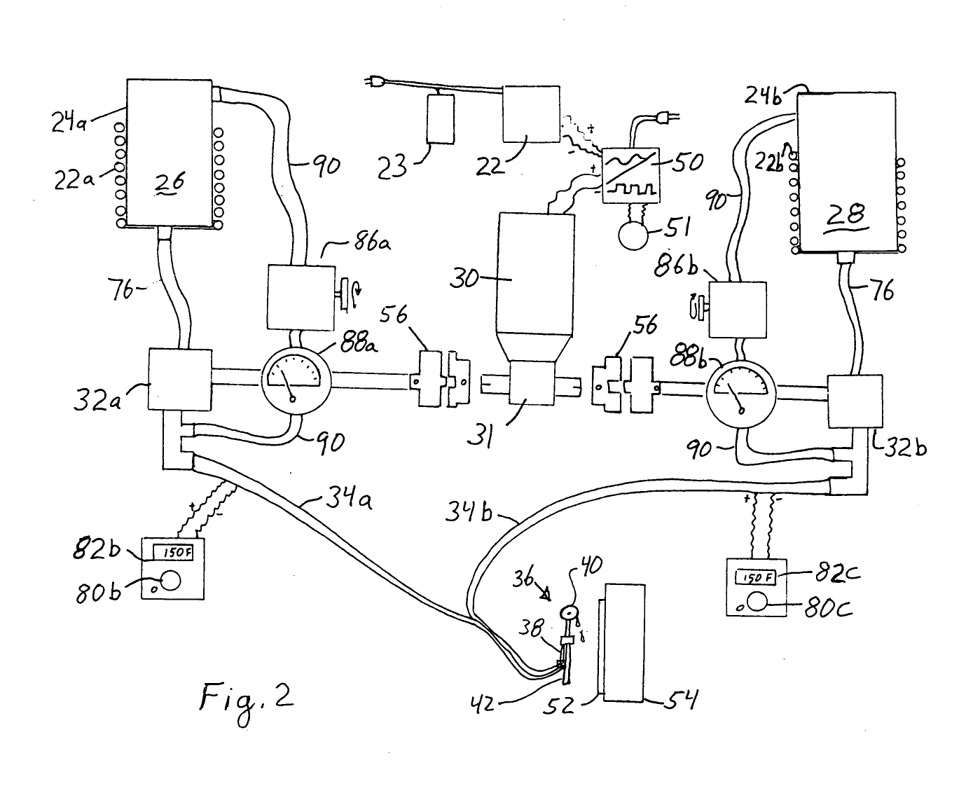

Referring to FIGS. 1-2, a portable roller system is shown that preferably, but optionally, has a portable cart 20 with a temperature controlled interior provided by an auxiliary heater 22 with an adjustable thermostat 23. The cart 20 can be omitted, but is preferred for portability reasons. One or more, and typically two containers or tanks 24 are mounted to the cart so the temperature of plural coating components can be maintained by the heater 22. There are preferably at least two tanks 24 containing plural materials for roller application. Preferably one container 26 contains a urethane or resin and the other container contains an activator 28. A single motor 30 drives appropriate pumps 32 through gear drives 31 to pump the materials 26, 28 through separate material lines 34a, 34b that are connected to a pressure feed roller 36. A resistance heater 35 is optionally wound around at least a portion, or all of the material lines 34 to keep the resin 26 and activator 28 in the lines in a flowable condition. The heater on the material lines 34 is optional.

The pressure feed roller 36 comprises any of numerous existing roller designs for continually applying a pressurized fluid to the roller. These pressure feed rollers 36 include those found in U.S. Pat. Nos. 4,692,048, 6,331,327 and 4,217,062, with the complete contents of each of those patents being incorporated herein by reference. The pressure feed roller 36 includes a perforated rolling element 40 and a bent fluid tube 41. A handle 42 is optionally included in the pressure feed roller 36. The handle 42 is typically connected to the bent fluid tube 41 in various ways, typically by a threaded connection or a bracket. The bent fluid tube 41 can have various configurations, and may fasten to the handle 42 various ways. The support tube 41 can have handle 42 formed around an inlet end of the support tube 41. The perforated rolling element 40 is thus connected to or fastened to the handle 42 in various ways using the bent fluid tube 41.

A static mixing tube 38 is used to mix the plural materials 26, 28 and provides them to the rolling element 40 of the pressure feed roller 36. The static mixing tube 38 is in fluid communication with the material lines 34 through which the separate coating materials 26, 28 are forced at a controlled rate. Preferably, but optionally, the outlet end of the static mixing tube 38 is close to the rolling element 40 so there is little distance and little time delay between the material exiting the outlet of the static mixing tube and reaching the rolling element 40. The static mixing tube 38 is preferably removably connected to the pressure feed roller 36, using any removable connection, with rotatable connections such as threads, bayonet locks being preferred. The static mixing tube 38 is preferably located between handle 42 of the pressure feed roller 36 and the rolling element 40. The motor(s) 30 are controlled by an on-off switch 39, or other appropriate speed control switch, which switch is preferably affixed to the handle 42 or adjacent thereto. “Adjacent” includes a switch connected to the handle 42, bent tube or roller or material transfer lines so as to be within an arms-reach of the handle 42 while the operator stands still and merely reaches for the switch.

Once mixed, the materials 26, 28 begin to harden and the viscosity increases greatly with time. The mixed materials 26, 28 are pressure fed through openings in the rolling element 40 which rolls the mixed materials onto a desired surface where the mixed materials 26, 28 harden to form a protective layer 52 on an object 54.

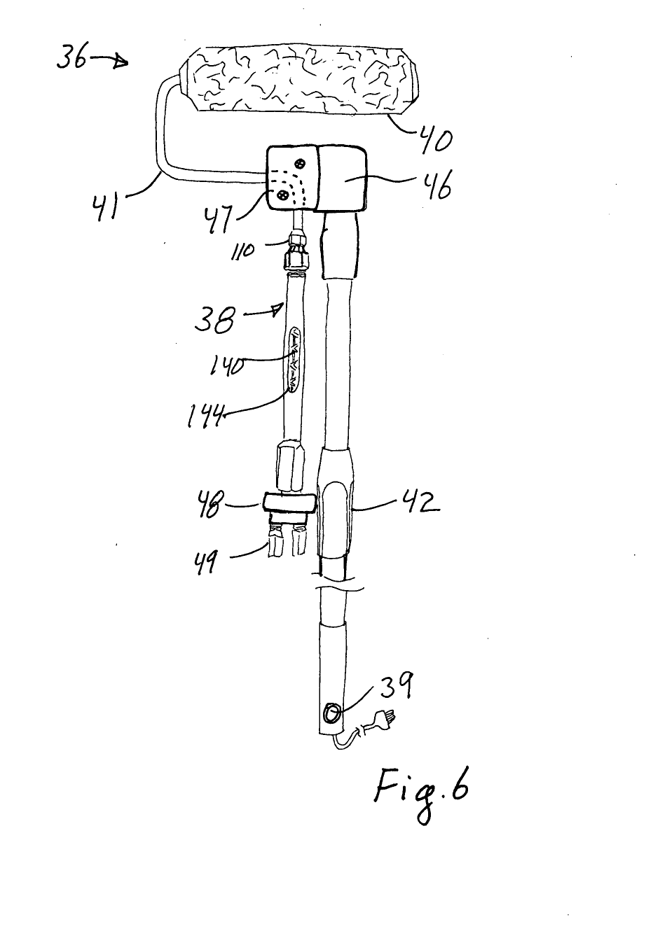

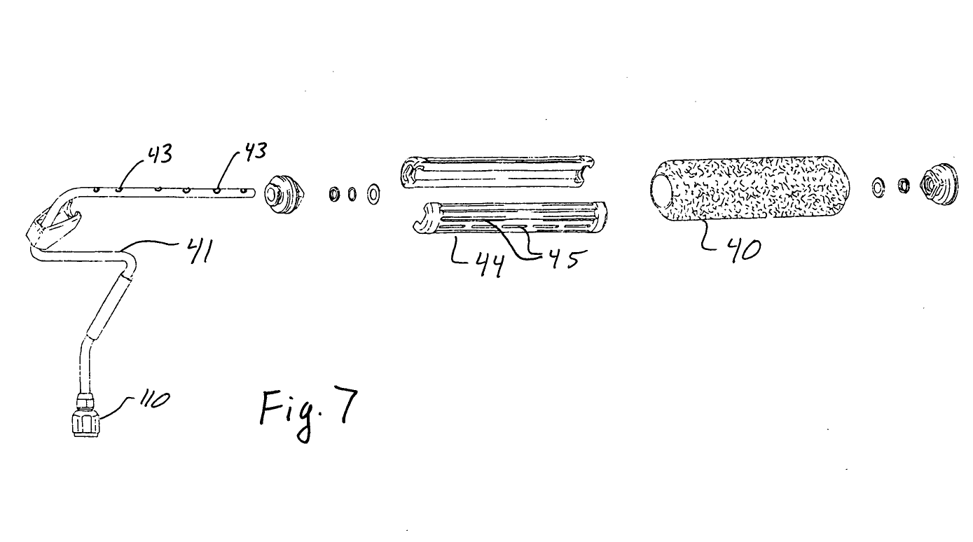

Referring to FIGS. 6-7, the pressure feed roller 36 is described in greater detail as having a tubular support frame 41 through which the material 26, 28 passes to feed the rolling element 40. The frame 41 is generally referred to herein as a fluid support frame. The fluid support frame 41 preferably has a single inlet that is removably fastened to an outlet end of the static mixing tube 38, and has a distal end with number of outlets 43 (FIG. 7). The distal end is typically straight and located inside the rolling element 40 and rollably supports rolling element 40. A roller support 44 is usually concentric with the distal end of the frame 41 and rotates about that distal end of the frame 41, usually concentric with the longitudinal axis of the distal end of frame 41. The rolling element 40 fits over the support 44 and also rotates about the distal end of the frame 41. Typically the rolling element 40 and support 44 comprise cylinders with rolling element 40 sliding over support 44. The support 44 has a plurality of openings 45 which can be of various sizes, shapes and locations and which are located to support the rolling element 40 while allowing the mixed materials 26, 28 to pass from the outlet openings 43, through the support 44 and its openings 45, and then through the rolling element 40. The frame 41, support 44 and rolling element 40 are disposable.

The frame 41 is optionally fastened to a removable handle 42 in various ways. FIG. 6 shows a clamp comprising a groove or recess formed in clamping block 46 fastened to the handle 42. A clamping plate 47 fits over the groove. The frame 41 fits into the groove and screws or other releasable fasteners removably clamp the frame into the groove in the clamping block 46. The frame 41 typically has a 90° bend in it and the groove is preferably L-shaped in order to accept this bent portion of the frame 41. The clamping block is preferably of metal and heavy in order to provide some weight which so that the operator can position the rolling element 40 so gravity causes the weight to push the rolling element 40 against the object being painted or coated. Alternatively, the clamp can be light weight. The clamp can take various forms to releasably fasten the frame to the handle, including releasable snap clamps, ties, brackets, and threaded connections.

In the illustrated embodiment of FIG. 6, the static mixing tube 38 is parallel to the elongated handle 42. The inlet end of the static mixing tube is fastened to a manifold 48 which has inlets 49 configured to fasten to the ends of the material lines 34a, 34b. Rotatable connections on the inlets are preferred, such as threaded connections or twist-lock connections. The manifold can optionally be fastened to the handle 42 in various ways, including releasable fasteners (e.g., screws), snaps, interlocking fittings, etc. The handle 42 can be a longer handle that is fixed in length or telescoping and extendable.

The cart 20 is advantageously a metal framed cart, preferably of steel. But other materials can be used, including polymers. The cart 20 could be open, but is preferably at least partially enclosed, with access doors 60 provided where and as needed to allow access to the interior space and the components mounted in that enclosed space. The location of the components will vary, as will the number, size and location of the access doors 60. The enclosed space in the cart 20 is also preferably insulated in order to help maintain the resin or urethane 26 and activator or catalyst 28 at desired temperatures and to maintain an even temperature within the interior of the cart. All surfaces of the cart 20 are preferably insulated, but it is believed suitable to insulate only the four, vertical sides 62 of the cart. A ½ inch thick, expanded polystyrene foam is believed suitable for the preferred embodiment. To increase portability, the cart 20 preferably has wheels 64 and a handle to push and position the cart. A rectangular cart with four wheels is believed suitable. A cart about three feet high, three fee long, and three feet wide is believed suitable, not counting the height of wheels 64

The top 68 of the cart 20 preferably has openings into which the tanks 24 are placed. The openings are sized and shaped to conform to the cross-section of the tanks 24. The tanks 24 optionally have one or more projections or rims 70 extending therefrom which are larger than the openings in the cart and which prevent the tanks from sliding entirely into the tank. If desired, one or more or all of the tanks 24 could be entirely enclosed within cart 20. But the two tanks 24 are preferably accessible from the exterior of the cart for refilling and for checking the level of material within the tanks.

Preferably a major portion of the tanks 24 is internal to the cart in order to maintain the temperature of the tanks and materials in the tanks. By major portion is meant a sufficient portion to allow the temperature to be maintained, and that typically requires over half of that portion of the tank that contains coating materials 26, 28 to be inside the cart 20. Two, 10 gallon tanks with locking, screw on lids that are sealed with a ½′ rubber gasket are believed suitable for the preferred embodiment. The tanks 24 are preferably sealed from atmospheric air in order to avoid deleterious effects on the materials 26, 28 that can be caused by the moisture in the atmospheric air.

The tanks 24 are preferably of polyethylene, with the projections 70 integrally molded with the tanks when the tanks are formed. The tanks 24 can be refilled through the removable lid, or one or more of the tanks 24 can be physically removed from the cart 20 when empty and replaced with a full tank.

The tanks 24 contain the materials to be rollered onto the surface to form the protective layer 52. For roller application, these materials are usually at least at room temperature, and as desired can be heated and maintained at an elevated operating temperature range between about 70° F. and 125° F. In order to help maintain this operating temperature, the heater 22 is provided. A 110V radiant space heater could be used. But preferably each tank 24a, 24b has a separate heater, such as a resistance heater 22a, wrapped around a portion or the entire tank 24. A separate heater 22a, 22b allows rapid heating, and lower power consumption. The resistance heaters are operable on a 110V line.

If a radiant space heater is used for the auxiliary heater 22, the heating capacity will vary with the size of the components and the environment in which the system is used. The heaters 22, 22a, 22b advantageously each have an adjustable thermostat that can be set to maintain the temperature, with only thermostat 23 for the auxiliary heater 22 being shown. The auxiliary heater 22 is preferably operated during the night mode, when the roller system is not being used. Advantageously, but optionally, the auxiliary heater 22 runs off a separate 110 volt line than does the remainder of the devices in the cart 20. During operation, the tank heaters 22a, 22b run off power from the power source 50, and as desired the power source 50 can also optionally provide power to the auxiliary heater 22. During prolonged non-operating periods, like overnight or over the weekends, the auxiliary heater 22 can be used to maintain the minimum temperature of the tanks 24 inside the cart, and the material lines 34 stored inside the cart. Because the roller system is not in operation during these prolonged periods, it is advantageous, but optional, to have the auxiliary heater run off the 110 volt line and provide no power to the drive inverter 50.

Advantageously, the temperature is controlled to maintain the temperature of the resin 26 and activator 28 at a minimum temperature of 72° F. or 5° above ambient, whichever is greater. The resin or urethane 26 is typically a blend of polyurethane and polyurea, and is usually colored. Activator or catalyst 28 is typically isocyanate. Both the resin and activator are moisture sensitive, and are preferably used when they are above about 72° F. Depending on the use of the system, other compounds can be used, and more than two tanks 24 and various coating material components can be used. The combination of auxiliary heater 22, and/or individual heaters 22a, 22b are selected to maintain the desired temperatures of the material lines 34a, 34b during storage, and to maintain the temperature of the tanks 24a, 24b during operation, but selected to maintain that desired temperature at sufficiently low power requirements that the system can operate on 110 V.

Referring to FIGS. 2-4, a variable temperature heater 22, 22a controlled by a thermostat can optionally be used to control the temperature of the tanks 24, and/or the material lines 34. A typical operating temperature for the materials 26, 28 is about 110° F. for use in the illustrated embodiment for roller application of pool coating materials. The material lines 34 are preferably maintained at room temperature, but could be maintained a higher temperature than the tanks 24 if desired for use with very viscous materials. But the temperature of the tanks 24 and material lines 34 can vary.

Advantageously the heater and temperature controls are on a separate panel or sub-panel so they can be grouped together. Preferably, but optionally, an on-off switch 78a can activate the heater(s) 22, 22a for the resin 26 and activator 28 in tanks 24a, 24b and switch them between a day, operational roller application mode and a night, non-operational-temporary-storage mode in which maintains a preset temperature on the tanks 24 and inside the cart 20 so the material in the lines 34 maintains a desired temperature above ambient for non-use periods. A separate switch 78b is preferably, but optionally provided to activate and deactivate the line heater 35. Preferably, but optionally, a separate temperature control 80a, 80b, 80c is provided for the tanks 24, and material lines 34a, 34b, respectively. Indicator lights can be provided to visually indicate the heaters are activated. An optional master on/off switch can be provided as desired, as can a timer reset button. The electrical connection of these controls is believed known or discernable within the skill in the art, and is not described in detail herein.

Preferably, but optionally, a temperature gauge 82a, 82b and 82c are provided for the tanks 24, and material line 34a, 34b, respectively. While a single temperature control 80a and temperature gauge 82a are shown for both tanks 24a, 24b, a separate temperature gauge and temperature control could be provided for each tank 24. Likewise, while separate controls and gauges 80b, 80c, 82b, 82c are shown for the material lines 34a, 34b, a single temperature control and temperature gauge could be used. Preferably, separate controls are provided because each roller component is likely to have a different preferred viscosity for roller application, and maintaining the preferred viscosity lowers the pumping power and pumping duty cycle. Preferably, the temperature controls and gauges are digital, but analog controls and gauges can be used, as could other controls and gauges.

The viscosity of the coating material will vary with the object being coated and the material used. The resin 26 and activator 28 used to form a pool coating are usually slightly viscous materials, having a viscosity of about 400 centipoises. But the specific component materials 26, 28 that are used, as well as the temperature of the component materials 26, 28 will affect the viscosity, and those materials can vary. The pumps 32 and motor or motors 30 must be sized appropriately for the viscosity of the coating materials to be used with pressure feed rollers 36 and the object to be coated or painted. Further, depending no only on the thickness of the materials being pumped through the lines 34 and the ease with which the material passes through the perforated rolling element 40, various sized motors and pumps will be needed.

Pumps 32 with a rating of a few gallons per minute are believed suitable for use in roller application truck bed liners with the above material. These pumps 32 are used to pump the resin 26 and activator 28 from tanks 24a, 24b, to the pressure feed roller 36. By placing both pumps 32 on a common shaft driven by a single motor 30, the pumps 32 can pump the plural component materials at the same rate. But during use of the roller system the pumping requirements will vary, depending in part on the object roller coated and the material used with the roller. Other types of pumps can be used, including peristaltic pumps. A peristaltic type of line pump is shown in U.S. Pat. No. 4,217,062, the complete contents of which are incorporated herein by reference.

The material 26, 28 is usually provided in equal amounts or a 1:1 ratio to the static mixing tube 38. But the gearing 56 could be changed to provide the material 26, 28 in other ratios. Ratios of 1:2 or multiples thereof are most common, but appropriate gearing could provide other ratios. Alternatively, each pump 32 could be driven by a separate motor, and each motor could be driven at a fixed speed or multiples of a fixed speed in order to provide fixed pump speeds at specified ratios. Thus, for example, a first motor could rotate twice as fast as the second motor, causing the pumps to pump material 26, 28 in a ratio of 1:2 or 2:1, depending on which motor drove which pump. Moreover, each of the separate motors 30 could be a variable speed motor to provide an adjustable ratio of materials 26, 28 to the static mixing tube 38. The motor(s) 30 are controlled by an on-off switch 39, or other appropriate speed control switch, which switch is preferably affixed to the pressure feed roller 38, and more preferably fastened to or near the handle 42.

Referring to FIGS. 2 and 4, a fluid line 76 places each tank 24 in fluid communication with one of the pumps 32. Preferably, one end of fluid line 76 removably connects to a fitting on the bottom of a tank 24 so the tank can be removed and replaced if desired. The other end of each fluid line 76 is connected to one of the pumps 32. A ½ inch port on the tank, and the same sized tubing are believed suitable for the preferred embodiment. The pumps 32 and motor 30 are preferably enclosed within the cart 20 to maintain the temperature of the plural component materials, resin 26 and activator 28. But enclosing the pump 32 and motor 30 also allows the heat from the pump to be used to maintain the operating temperature of the cart 20 and roller materials enclosed within the cart.

The plural component materials, the resin 26 and the activator 28, are sensitive to moisture as well as being sensitive to temperature. As the level of material within each tank 24 lowers, air enters the tank and the air can contain sufficient moisture to affect the performance of the roller application and hardening of the materials. An airline is attached to each sealed tank and also connected to a desiccant filter that removes moisture from the air as the air passes through it to the tank. Alternatively, the desiccant filter can be removed, and the air line can have a distal end opening into the interior of the cart 20, because the heat inside the cart can drive out sufficient moisture to provide a source of air that is sufficiently moisture-free to avoid undesirable affects on the materials in the tanks 24.

Referring still to FIGS. 1-2, a pressure regulator 86 is preferably, but optionally used to regulate the pressure in the material line 34 so that the pressure in each material line 34 can be independently adjusted using pressure regulator 86. A pressure sensor, illustrated as a pressure gauge 88, monitors the pressure to make use of regulator 86 easier.

In the illustrated embodiment, each pump 32a, 32b pumps at a constant rate in order to use a low power for the pumps. The amount of material 26, 28 provided to pressure feed roller 36 is regulated or varied by returning a portion of the pump output to the tanks 24. Each pump 32a, 32b has a return line 90a, 90b running from the downstream side of the pump 32 back to the respective tank 24a, 24b. The pressure regulator 86a, 86b is adjusted to vary the amount of material 26, 28 returned to the respective tank 24a, 24b, and that regulates the amount of material in the respective material lines 34a, 34b. The pressure gauge 88a, 88b indicates the pressure in the return line and also indicates the pressure in the associated material line 34a, 34b. The pressure gauges 88a, 88b could thus also be placed on the respective material lines 34a, 34b. By monitoring the pressure in the lines downstream of the pumps 32a, 32b using gauges 88a, 88b, and by adjusting the pressure regulators 86a, 86b, the pressure in the material lines 34a, 34b can be adjusted to a desired pressure for each line. Each line 34a, 34b is of a fixed cross-sectional area so by varying the pressure, the flow rate of material to the pressure feed roller 36 can also be varied or adjusted. The pressure regulators 86 and gauges 88 are optional, and may be omitted, especially if the material being applied is fairly thin and not very viscous.

Referring to FIGS. 1-2 and 4, if pressure regulators are used, then the output of the pressure sensors are preferably visually displayed, as through pressure gauges 88a, 88b on an externally accessible control panel. Controls 89a, 89b allow adjustment of the regulators 86a, 86b. Running the controls 89a, 89b to an externally accessible control panel avoids having to open doors 60 in the cart to access the gauges 88 and regulators 86 to adjust the pressure in the material lines 34. If pressure regulators 86 are not used, then the controls 89 are not needed.

Gauges 88 and regulators 86 with an upper pressure range of a few hundred psi are believed suitable for the illustrated embodiment suitable for roller application of pool liner material. For thinner coating materials with a viscosity of about 400 centipoise, a pressure range of about 20-110 psi is believed suitable. The pressure regulators 86 are preferably, but optionally constructed with seals made of polytetrafluoroethylene (PFTE). The PFTE seals resist seal swelling which can require more power to operate the regulators 86. The PFTE seals are also more resistant to degradation from the materials likely to be used in the roller system, and thus maintain the operating pressures better and in turn require lower power to drive the pumps 32 as the regulators wear with use.

The motor 30 is placed inside the cart 20 to allow the heat from the motor to be used to maintain the temperature inside the cart. If the motor 30 generates too much heat, it can complicate the operational control of heater 22. Thus, it may be advantageous to place the motor 30 in a sub-compartment within the cart 20, and to insulate that sub-compartment. Moreover, it is believed possible, but not desirable, to have the motor 30 located outside of the heated portion of the cart 20. Preferably though, the motor 30 is placed inside the cart 20, and heat from the motor is used to help maintain the temperature of coating or painting materials 26, 28.

The preferred pressure feed roller 36 preferably, but optionally, does not use gas or air to force the materials 26, 28 through the mixing tube 38 and through the pressure feed roller and out the rolling element 40. Rather, the pressure feed roller 36 preferably uses the pressure from pumps 32 to force the materials 26, 28 through the static mixing tube 38 and through the rolling element 40. A suitable pressure feed roller is provided by Graco.

Material lines 34a, 34b carry the resin 26 and activator 28 from the hydraulic pumps 32 to the special pressure feed roller 36. Even though the pressure carried by these lines is low, the lines 34 are preferably a high strength line that reduces the radial expansion of the line under operating pressures. The lines 34 are preferably a made of a stiff material that does not expand radially under pressure. A line 34 having a Teflon tube with a flexible, stainless steel braid surrounding the Teflon for burst resistance is believed suitable for highly viscous materials. A burst pressure on these Teflon-steel braided material lines 34 of about 5,000 psi is desirable. The general operating pressure from the material pumps 32 is usually less than a few hundred psi with 20-110 psi being common for thinner, two-part urethane paints, so the, pressure in the line 34 is less than 100 times the burst strength of the line. If more vicious coating materials are used, then the pressures can increase to several thousand psi, and the higher strength lines are desirable. In a less preferred embodiment, lower strength lines 34 can be used, having a burst pressure of about 2,500 psi.

When the roller system is not being used, the material lines 34 are disconnected from the pressure feed roller 36 and connected to the tanks 24 by connectors on the tanks so that the materials 26, 28 can cycle through the lines periodically to eliminate material build up in the lines and to keep the material in suspension. A circulation of 10 minutes every 4 hours via an automatic timer that is tied to the pump motor 30 is believed suitable for the preferred embodiment. The appropriate time intervals will depend on the materials used, the insulation of the cart 20, the size of the heater and the environmental temperature.

If the connector is placed on the tank 24 external to the cart 20, then the tank can be readily disconnected and removed from the cart. The connection with the activator tank 24a is preferably, but optionally, provided internal to the cart 20. The activator 28 is more temperature sensitive so the internal location of the connector helps maintain the temperature. Advantageously, the cart 20 has a shelf or sufficient space to allow the entire material line 34 to be placed inside the cart 20 when the roller application system is not in use. This allows the temperature of the entire line 34 to be maintained by the cart 20 and its temperature controlled interior via heater 22. The shelf or space to store the material lines 34 is advantageously accessible through a door 60.

The motor 30 can take the form of any motor that is commercially available now, or in the future. Ideally, the motor is a 110 volt, double stack, low-ramp DC motor (DSLR). The motor is preferably a 90V motor, about 1.7 hp, operating at about 2500 rpm. The output of motor 30 is through a rotating drive shaft which drives gearbox 31. A modular designed gear box is preferred, with a gear reduction of about 5:1 believed suitable, with an output speed of about 2500 rpm. Advantageously, but optionally, helicoid gears are used with fiberglass bushings on the gears and/or input and output shafts, to provide high capacity and high efficiency. Further, the gear shafts are optionally hollow, and larger than would be normal for a solid shaft gear system. The gear reduction 31 preferably uses synthetic lubricants to reduce temperature and to increase operating and service life. The output from gear reduction 31 is preferably through a large diameter shaft allowing a larger diameter bearing to accommodate increased torque from the motor 30 and gear reduction 31. To simplify the system when the materials 26, 28 are not very viscous, the gear reduction 31 can be omitted and the motor 30 can directly drive the pumps.

If thick and very viscous materials are used, then the 110 line input voltage preferably passes through a drive inverter 50 and preferably that also uses a pulse width modulated (PWM) signal to reduce the operating current to the motor 30. The drive inverter 50 converts the 110 volt AC current into a DC current, and preferably, but optionally, into a square wave DC current. This is believed to improve efficiency and life of the motor 30. The DC current is applied to the motor 30 and to the heaters 35 on the material lines 34, and to any heaters on the tanks 24. Preferably, but optionally, a variable speed control 51 is provided to vary the speed of the motor 30 by varying the voltage from the drive inverter 50 to the motor.

Preferably, the motor 30 is of modular construction and is coupled to the pumps 32 through couplers 56. The couplers 56 allow the motor 30, or either of the pumps 32, to be more easily removed. The pumps 32 are high efficiency, positive displacement pumps which do not loose pressure under extreme operating conditions. The viscosity of the resin 26 and activator 28 will vary, and the pumps have to work efficiently, with low power requirements.

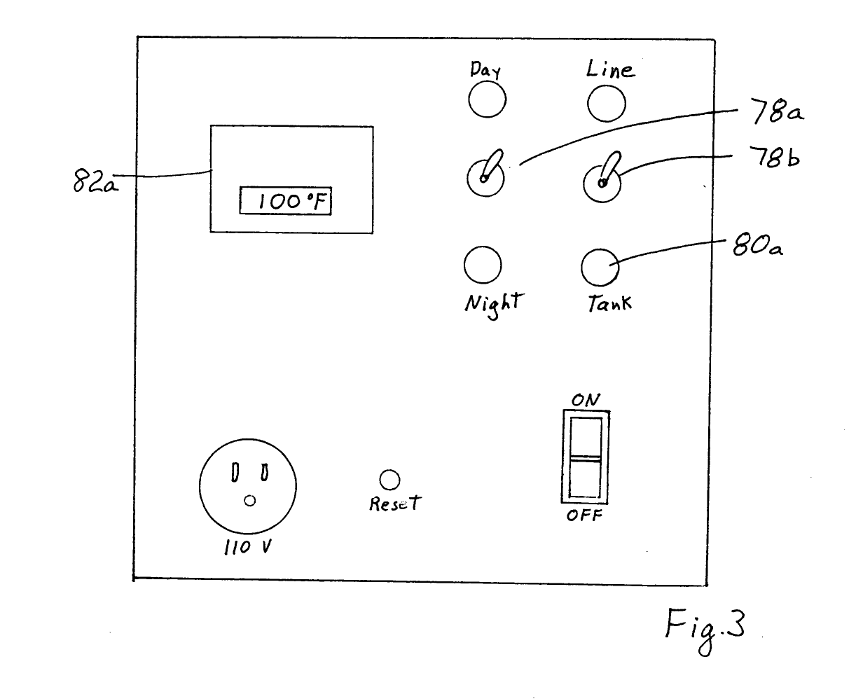

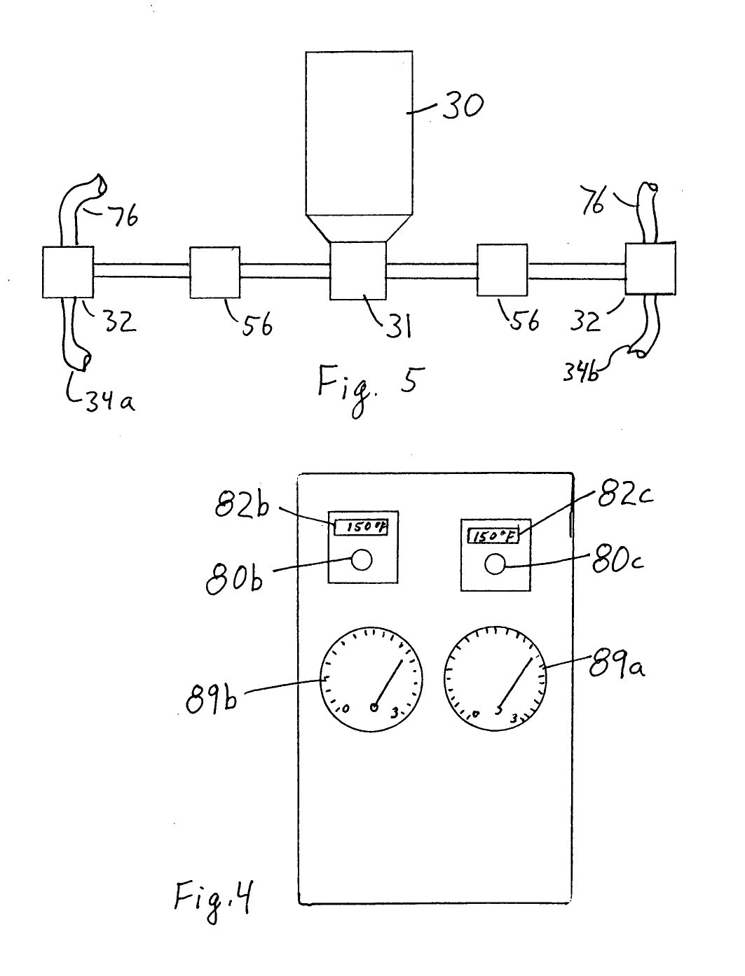

To use the system, the cart 20 is connected to a standard 110V power outlet. Materials 26, 28 are placed in the tanks 24, and the power is turned on using a master power switch (FIG. 3). The heaters 22a, 22b around the tanks 24 and any auxiliary heater 22 inside the cart 20 are activated and the desired temperatures set using the controls 80. If the materials 26, 28 do not require heating, then the heaters 22 and associated temperature control equipment and instruments are either omitted from the system or turned off. When the temperature of materials 26, 28 reach a desired temperature (e.g., about 110° F.) as indicated by the sensors or by the displays 82, the heaters 35 on the material supply lines 34 are activated if such heaters are present. The line heaters 35 can be omitted for materials 26, 28 that are thin and flowable at room temperature. Shortly before, or after activation of the line heaters 35, the material lines 34 are connected to the tanks 24 and the pressure feed roller 36 is connected to the material lines. When the material 26, 28 is at a suitable temperature and suitably flowable, the pumps 32 are activated and adjusted as desired. A pressure of about 300 psi or less, and preferably about 20-110 psi is believed suitable for the illustrated embodiment of roller application of pool coating material or two-part urethane paints. But again, the pressure will vary with the materials used so while pressures of less than a couple hundred psi are usable with thinner coating material, the thicker material can require much higher pressures. The desired object 54 is then rollered to form coating 52.

After roller application is finished, the power to the heaters 22 is turned off. The material lines 34 are disconnected from the pressure feed roller 36, and the pressure feed roller is discarded, or at least the static mixing tube 38 and rolling element 40 are discarded while the remaining portions may be cleaned with suitable solvent such as paint thinner, acetone or other solvents appropriate for the material being applied by the roller. The coating materials harden, sometimes within a few minutes, and the mixed materials 26, 28 on the rolling elements 40 and static mixing tube 38 become hardened, rendering the mixing tube 38 and rolling element 40 unusable. The ends of the material lines 34 that were connected to the pressure feed roller 36 are connected to the tanks 24 so material can recirculate through the lines 34 and tanks 24. The system is switched to the night mode using switch 78b, which optionally lowers the temperature in the tanks 24 to a standby or overnight temperature that is optionally lower than the operating roller application temperature, and that periodically activates pumps 32 to recirculate material 26, 28 through the lines 34.

The roller system disclosed herein can operate on a standard 110V power outlet. The current drawn by the pump 32 and line heaters 35 varies with the materials 26, 28. As the viscosity of the materials varies, different motors can be used. If more viscous materials are used, a double stack, DC motor becomes more desirable as it provides high torque at low amperage, and is a small (e.g., 1.75 HP) motor. The cart 20 of the present invention is sufficiently portable that it can fit into an elevator and be moved into position by a single person.

Referring to FIG. 8, a further embodiment of the pressure feed roller 36 is in which the two material lines 34a, 34b fasten to the end of a handle 42 and extend internal to the handle to the mixing manifold 48 located at a distal end of the handle. The mixing manifold has fittings in fluid communication with the material lines 34 and combines those plural inputs into a single outlet in fluid communication with the inlet end of mixing tube 38. In the depicted embodiment the mixing tube is made part of the tubular frame 41 by inserting a static mixing tube into the portion of the tubular frame that fastens to the handle 42. Thus, the mixing tube 38 need not be a separate piece from the frame 41, but could be a part of the frame and pressure feed roller 36. The frame 41 fastens to a mating fitting on the manifold 48 which in this embodiment is located at the distal end of the handle, adjacent the pressure feed roller 36. Switch 39 is in electrical communication with the motor 30 to control the feed of materials 26, 28 to the pressure feed roller 36.

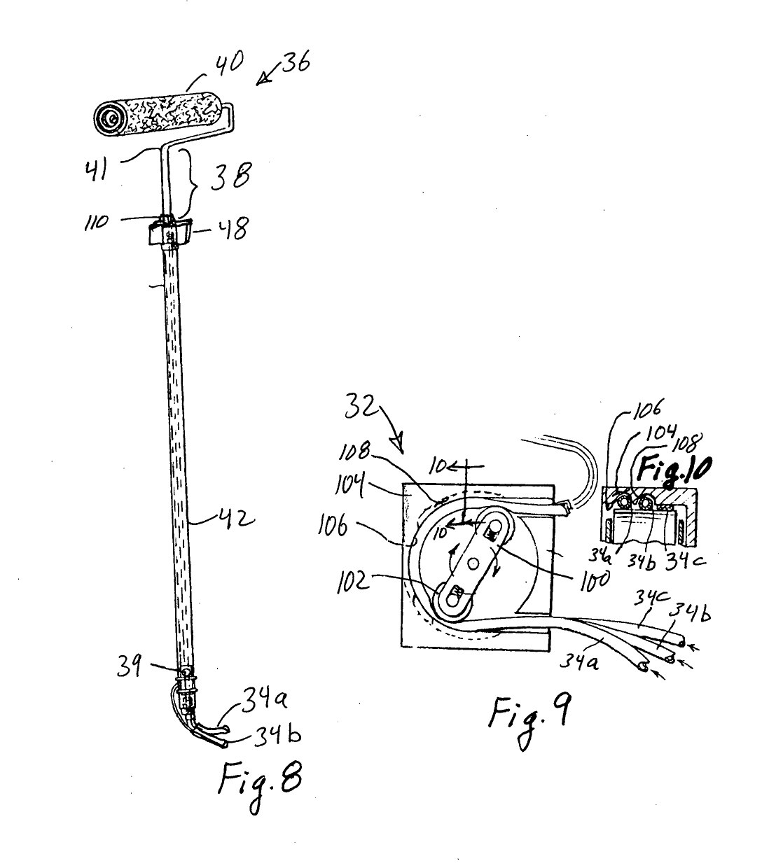

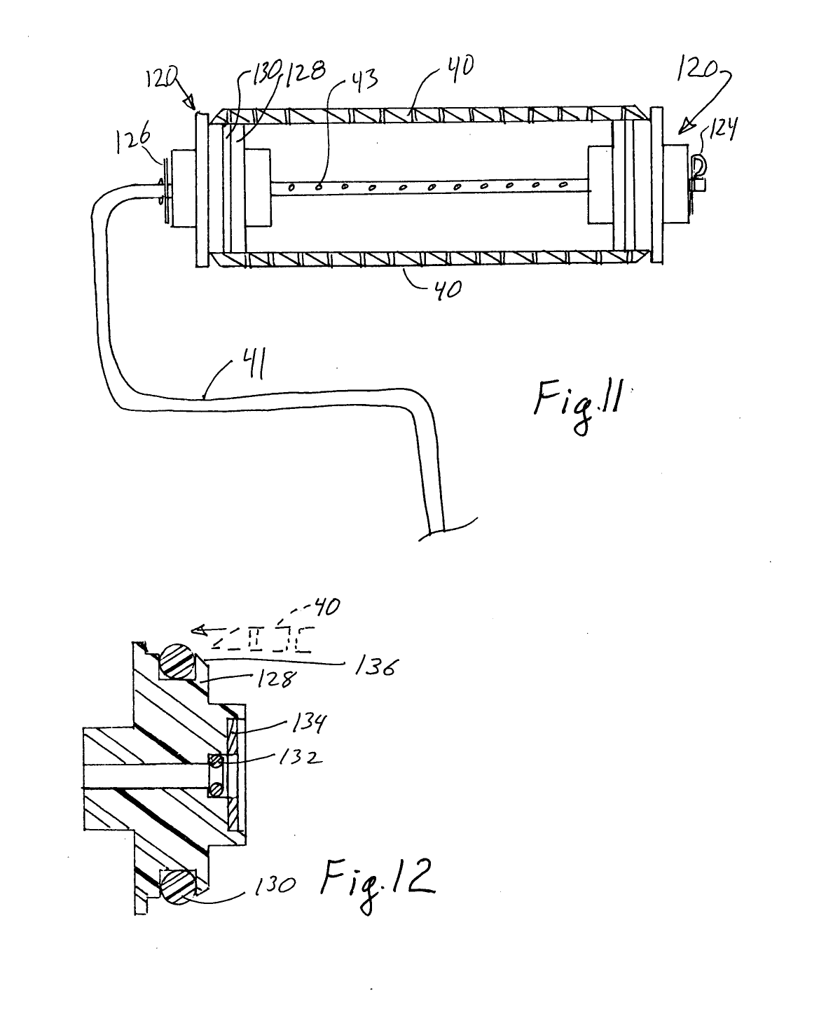

Referring to FIGS. 8-9, a further embodiment of a pump 32 is shown, comprising a peristaltic pump having a motor (not shown) rotating a bar 100 having a roller 102 on each opposing ends of the bar. The bar 100 and pinch rollers 102 are located in a housing 104 having walls 106 defining a cylindrical cavity with the material lines 34 placed between the rollers 102 and walls 106. Three material lines 34a, 34b, 34c are shown. As the bar 100 rotates, the pinch rollers 102 pinch or compress the material lines 34 and force material 26, 28, etc. through the lines. The shape of the cavity formed by the wall 106 can vary as indicated in the dashed lines in order to vary the amount that one or more lines 34 are compressed, as reflected by FIG. 9. The shape of wall 106 relative to the location of one or more lines 34a, 34b, 34c can be used to vary the relative amount of material pumped through each line 34. Recesses or grooves 108 can thus be placed in the wall 106 about a portion of the generally cylindrical cavity to vary the amount of material pumped through the material lines 34.

There is also provided a mixing assembly for use with a preexisting pressure feed roller assembly having a handle 42, a bent fluid tube 41, and a pressure rolling element 40. The bent fluid tube 41 has a connector 110 for connecting to a source of fluid material to be applied by the rolling element rollably supported on a distal end of the bent fluid tube. The connector 110 is typically a threaded connector, but other connectors could be used. The manifold 48 with its two or more inlet fittings 49 releasably connect to distal ends of material transfer lines 34. The manifold has a single outlet placed in fluid communication with the inlet of the static mixing tube 38. Typically the mating fittings are also threaded connections. The mixing tube outlet is placed in fluid communication with the bent fluid tube, usually via threads mating with the threaded connector 110. Preferably, but optionally, the manifold is fastened to the handle 42, and more preferably releasably fastened to the handle. Likewise, the mixing tube can also be fastened to the handle 42, either directly by being placed inside the handle 42 (FIG. 8) or by being directly fastened to the handle, or by having the bent fluid tube 47 being fastened to the handle Optionally, the static mixing tube comprises a portion of the bent fluid tube (FIG. 8).

The above description is given by way of example, and not limitation. Given the above disclosure, one skilled in the art could devise variations that are within the scope and spirit of the invention, including various ways of using the present method and roller apparatus to coat various surfaces 52 other than swimming pools. For example, concrete surfaces or surfaces on the inside or outside of buildings could be painted or coated with the method and apparatus of this invention. Other surfaces, preferably, but optionally, hard surfaces, can be coated for the purpose of waterproofing and abrasion or impact resistance using the resins involved here. Further, the various features of this invention can be used alone, or in varying combinations with each other and are not intended to be limited to the specific combination described herein. Thus, the invention is not to be limited by the illustrated embodiments.

This invention also further comprises a method of applying a multi-part epoxy by a pressure feed roller by placing a first end of material transfer lines 34 in fluid communication with appropriate 24 containers of activator and resin 26, 28. Multiple part coatings 26, 28 are pumped to a static mixing tube 38 which has an outlet in fluid communication with pressure feed roller 36. Preferably the outlet end of the mixing tube 38 is threadingly engaged with the inlet end of ht bent fluid tube 41. The mixing tube 38 mixes the activator and resin 26, 28 and the bent fluid tube 41 passes the mixed material to the rolling element 40 for coating a surface 52 on object 54 (FIG. 2). Preferably, but optionally, the method in includes fastening the mixing tube to the handle 42, with the bent fluid tube 41 also being fastened to the handle. Switch 39 activates the pump(s) 56 to regulate the material provided to the mixing tube 38 and rolling element 40.

When coating is completed, the mixing tube 38 and manifold 48 can be removed from the handle 42 and discarded. Alternatively, the mixing tube 38 can be removed and discarded while the manifold 48 is reused, preferably after removing any intermixed materials that have hardened in the manifold. Likewise, the pressure feed roller 36 can be removed and replaced. The manifold 42 and mixing tube 38 can be provided as a unit, or provided with pressure feed roller 36 and bent fluid tube 41.

Referring to FIGS. 10-11, a pressure feed roller 36 is shown with the rolling element 40 in cross-section. The bent fluid tube 41 has a distal end that passes through two end caps 120 that rollably support that distal end, with a plurality of outlets 43 in the distal end located between the end caps. The end caps 120 are prevented from moving along the length of the distal end by a cap stop 122 and a cotter key 124 each of which are on opposing sides of the end caps. The cap stop 122 comprises a raised portion on the exterior of the bent fluid tube 41 which abuts a stop washer 126 while a cotter key 124 extends through a hole in the distal end of tube 41 to limit movement of the end cap 120 adjacent the cotter key. In the embodiment of FIG. 7, the lateral movement is prevented by a bracket cooperating with the bent shape of the tube 41. The bent fluid tube 41 has its end plugged so material cannot flow out through the hole that accepts the cotter key 124.

The end caps 120 each have a cylindrical boss 128 sized to mate with the inside diameter of the rolling element 40. A seal, such as an elastomeric O-ring seal 130 encircles the boss and rests in a recess in the boss to form a fluid tight seal between the boss 128 and the inside of the rolling element 40. *

Referring further to FIG. 11, the distal end of the bent fluid tube 41 passes through a cylindrical hole in the end caps 120, with another sealing element, such as O-ring seal 132 (FIG. 11) preventing fluid transfer from the inside of the rolling element 40 along the length of the distal end. A disk shaped elastomeric washer can encircle the distal end of the bent fluid tube 41 adjacent seal 132 to further help prevent fluid transfer out of the inside of rolling element 40 be Preferably the inner edge of the boss 128 has a chamfer 136 inclined in a direction that makes it easier to push the rolling element 40 onto the boss 128 and across seal 130.

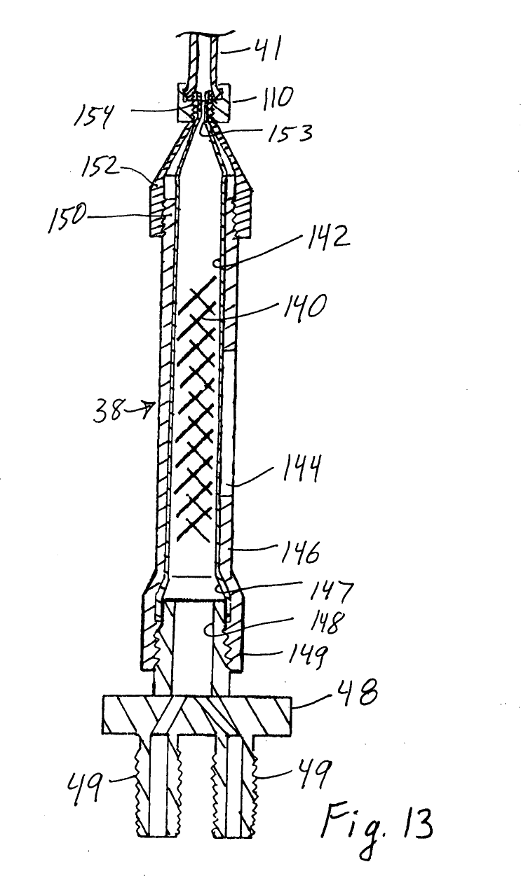

Referring to FIGS. 6 and 13, a further description of the static mixing tube 38 is provided. Preferably, the static mixing tube 38 comprises a static mixing element 140 contained in a thin walled tube 142. A #18 or #24 static mixing element 140 having 18 or 24 elements, respectively. These static mixing elements are about ⅜ inch diameter, and about 8-10 inches long, and contained in a tube 39 having one end connected to the pressure feed roller 36 and the other end connected to the material lines 24. The tube 142 could be of transparent material such as a suitable strength and chemical resistive plastic and that configuration is shown in the drawing.

The tube 142 is enclosed in a housing 146, which preferably, but optionally, has an opening or transparent window 144 allowing 144 (FIG. 6) in a portion of the tube 142. The window 144 is large enough and located such that the operator can visually see materials 26, 28 pass through the mixing tube with the unaided eye. If the tube 142 is made of opaque material, then preferably a suitable transparent window is also formed in the tube 142 to coincide in location with the window 144.

The inlet end 147 of the tube 142 is flared to fit over a tapered outlet 148 of the manifold 48 to help form a fluid seal. The inlet end 149 of the housing 146 is threaded to mate with corresponding threads on the manifold outlet 148. Internal threads are shown, but the parts could be configured so the housing 149 had external threads mating with internal threads on the outlet 148. The outlet end 150 of the housing 146 is threaded to mate with threads on connector 152. External threads are shown, but the location of threads on the connector 152 and outlet end 150 could be reversed. The connector 152 has an outlet end 154 that is threaded to mate with the flared swivel connection. 110 on the bent fluid tube 41. An outlet end 153 on the tube 142 is tapered to fit inside the tapered outlet end 154 on the connector 152 and preferably, but optionally, forms a fluid tight seal. The connector 152 can be threaded along the length of housing 146 until it abuts and seals against the outlet end 158 of the tube 142. The connector 152 thus encloses and positions the outlet ends 153, 154 to provide a fluid tight connection to the connector 110 on the bent fluid tube inside 41.

The housing 142 supports the thin walled housing 142, so the housing 142 is preferably, but optionally made of stronger material such as metal, preferably steel. Further, the threaded connections provide a releasable connection that allows the housing 146, tube 142 and mixing element 140 to be removed and discarded. Moreover, the tube 142 and mixing element 140 could be removed from housing 146 and discarded, with the same housing 146 being reused with a new tube 142 and mixing element 140.

It is believed possible to combine the fluid tube 142 and housing 146 into one part. Further, other ways of enclosing and connecting the static mixing tube 140 exist and can be used. The tapered outlet on the tube 142 and housing 146 can be less severe and even omitted if suitable sealing connections are provided.

The foregoing is considered as illustrative only of the principles of the invention. Furthermore, since numerous modifications and changes will readily occur to those skilled in the art, it is not desired to limit the invention to the exact construction and operation shown and descried. The above description is thus given by way of example, and not limitation. Given the above disclosure, one skilled in the art could devise variations that are within the scope and spirit of the invention. The various features of this invention can be used alone, or in varying combinations with each other and are not intended to be limited to the specific combination described herein

What is claimed is:

1. A portable system for roller application of a coating material, comprising:
at least two containers for holding at least two coating materials during use of the system;
first and second material transfer lines each having a first end adapted to be placed in fluid communication with a different one of the containers, each material transfer line having a second end;
a static mixing tube and a pressure fed rolling element for roller application of the coating material, the pressure feed roller being in fluid communication with an outlet of the static mixing tube and an inlet end of the static mixing tube being in fluid communication with the second ends of the first and second material transfer lines;
at least one pump arranged to pump material through the first and second transfer lines to the static mixing tube during use of the system and in response to a manually activated switch located adjacent the mixing tube and roller.

2. The portable roller system of claim 1, further comprising a cart holding the first and second containers.

3. The portable roller system of claim 1, further comprising a cart holding the first and second containers and a heater in thermal communication with the at least two containers, the heater providing sufficient heat to maintain the containers at a suitable operating temperature when coating material is placed in the containers during use of the system.

4. The portable roller system of claim 1, further comprising a cart having an enclosed space and holding at least a major portion of the first and second containers in that enclosed space, the cart having a heater in the enclosed space and in thermal communication with the at least two containers.

5. The portable roller system of claim 1, wherein the rolling element is releasably fastened to a handle.

6. The portable roller system of claim 1, wherein the at least one pump comprises one motor driving two pumps with each of the two pumps pumping material through one of the first and second material transfer lines during use of the system.

7. The portable roller system of claim 1, wherein the at least one pump comprises two motors each driving a separate pump.

8. The portable roller system of claim 1, wherein the at least one pump comprises a first and second pump with the first pump in fluid communication with a first pressure regulator which recirculates material from the first container to control the pressure in the first material line, and wherein the second first pump is in fluid communication with a second pressure regulator which recirculates material from the second container to control the pressure in the first material line.

9. The portable roller system of claim 1, wherein the rolling element is connected to a handle having a switch in electrical communication with the at least one pump to activate the pump.

10. The portable roller system of claim 1, wherein there is a single motor driving two pumps at pump different speeds so more material passes through one material transfer line than the other material transfer line.

11. The portable roller system of claim 1, wherein the static mixing tube is releasably connected to the pressure fed rolling element.

12. A portable system for roller application of a coating material, comprising:
a portable cart having an enclosed interior;
at least two containers for holding at least two coating materials during use of the system, the containers having a major portion enclosed within the interior of the cart;
first and second material transfer lines each having a first end adapted to be placed in fluid communication with a different one of the containers, each material transfer line having a second end;
a static mixing tube having an inlet end in fluid communication with the second end of each material transfer line and having a mixing tube outlet end;
a pressure feed roller having a rolling element rollaby supported by a bent fluid tube which is in fluid communication with the outlet end of the static mixing tube.
means for moving coating material from the first and second containers, through the material lines to the pressure feed roller during use of the system.

13. The portable system of claim 12, wherein the means comprises a separate pump in fluid communication with each material transfer line.

14. The portable system of claim 12, further comprising a heater located to heat the material in at least one of the containers to a temperature suitable for application by the rolling element.

15. A portable system for roller application of viscous coating material, comprising:
a portable cart having wheels and an enclosed interior;
at least two containers on the cart, each container adapted to hold a coating material during use of the system;
a first heater in conductive thermal communication with the at least two containers;
first and second material transfer lines each having a first end adapted to connect to a different one of the containers, each material transfer line having a second end;
a static mixing tube having an inlet end in fluid communication with the second end of the material transfer lines and having an outlet end;
a pressure feed roller for roller application the coating material, the roller having a rolling element in fluid communication with the outlet end of the static mixing tube;
at least one pump located and configured to pump material from the containers through each material transfer line to the static mixing tube.

16. The system of claim 15, wherein the at least one pump comprises a single motor driving a separate pump associated with each material transfer line.

17. The system of claim 15, wherein the at least one pump comprises a first motor and first pump located to pump material through the first material transfer line to the static mixing tube, and a second motor and second pump located to pump material through the second material transfer line to the static mixing tube.

18. The system of claim 15, wherein the pressure feed roller and static mixing tube are fastened to a handle.

19. The system of claim 15, wherein the pressure feed roller and static mixing tube are releasably fastened to a common handle.

20. The system of claim 15, wherein the first container contains an activator and the second container contains a resin.

21. The system of claim 15, further comprising a heater inside the cart and connected to a power source to heat the containers.

22. The system of claim 15, further comprising a switch on a handle to which the pressure feed roller is connected, the switch being placed in electrical communication with the motor to regulate the material pumped to the rolling element.

23. The system of claim 15, further comprising an elongated handle to which the pressure feed roller is attached, with the static mixing tube being fastened generally parallel to the handle and a switch regulating the pump speed connected to the handle.

24. The system of claim 15, further comprising an elongated handle to which the pressure feed roller is releasably connected by a bent fluid tube, with the static mixing tube comprising a portion of the bent tube.

25. A pressure feed roller having a bent fluid tube and a pressure rolling element rollably supported on a distal end of the bent fluid tube, comprising:
a handle having a manually operated electric switch connected to the handle;
a manifold having at least two inlet fittings each adapted to releasably connect to distal ends of flexible and elongated material transfer lines, the manifold having an outlet in fluid communication with the inlet fittings;
a static mixing tube having an inlet and outlet, with the static mixing tube inlet being in fluid communication with the manifold outlet, the mixing tube outlet being in fluid communication with the bent fluid tube.

26. The pressure feed roller of claim 25, wherein the manifold is fastened to the handle.

27. The pressure feed roller of claim 25, wherein at least one of the mixing tube and manifold is fastened to the handle.

28. The pressure feed roller of claim 25, wherein the mixing tube comprises a static mixing element placed inside a portion of the bent fluid tube.

29. The pressure feed roller of claim 25, wherein the switch electrically activates at least one pump to provide two different coating materials through material lines connected to the manifold.

30. The pressure feed roller of claim 25, wherein the static mixing tube is located inside the handle.

31. An apparatus for use with a pressure feed roller having a bent fluid tube and a pressure rolling element rollably supported on a distal end of the bent fluid tube, the bent fluid tube having a rotatable fluid coupling on an inlet end of the tube, comprising:
a manifold having at least two inlet fittings adapted to releasably connect to distal ends of material transfer lines, the manifold having an outlet in fluid communication with the at least two inlet fittings each connected to a material transfer line with at least one material transfer line connected to a container having a heater in thermal communication therewith;
a static mixing tube having an inlet and outlet, with the static mixing tube inlet being in fluid communication with the manifold outlet, the mixing tube outlet being in fluid communication with a fitting configured to fasten to the rotatable fluid coupling.

32. The apparatus of claim 31, further comprising a handle connected to at least one of the manifold or mixing tube.

33. The apparatus of claim 31, wherein one material transfer line contains a urethane and the other material transfer line contains an isocyanate.

34. The apparatus of claim 31, wherein one material transfer lines is connected to a container of activator and one material transfer line is connected to a container of resin.
